(19) United States
(12) Patent Application Publication
(10) Pub. No.: US 2026/0055883 A1
(43) Pub. Date: Feb. 26, 2026

(54) Ring Wheel Generator

(71) Applicant: Joel Hilmo, Olympia, WA (US)

(72) Inventor: Joel Hilmo, Olympia, WA (US)

(21) Appl. No.: 19/305,528

(22) Filed: Aug. 20, 2025

Related U.S. Application Data
(60) Provisional application No. 63/685,830, filed on Aug. 22, 2024.

(51) Int. Cl. F21V 23/02; B60Q 1/00; B60R 16/03; H02K 7/18; H02K 11/00

(52) U.S. Cl. CPC F21V 23/02; B60Q 1/0017; B60R 16/03; H02K 7/1846; H02K 11/0094

(57) ABSTRACT

A modular ring wheel generator designed to convert rotational energy into electrical energy or electrical energy into rotational motion. The invention features a novel three-ring coaxial assembly comprising an outer coil ring, an intermediate magnet ring, and an inner bracket ring. The outer coil ring includes a serpentine coil winding supported by radially aligned spacers, while the magnet ring rotates freely within a ball-bearing raceway housed in the bracket ring. This unique configuration enables efficient electromagnetic induction without direct contact between moving parts. The generator supports dual functionality: in one mode, it powers LED lights mounted on a wheel rim using the wheel's rotation; in another mode, it acts as a motor by converting electrical input into rotational motion. The system is compact, durable, and designed for easy integration into existing wheel assemblies, offering both aesthetic and functional enhancements through its use of persistence of vision lighting effects.

This utility patent application is based on and claims the filing date benefit of U.S Provisional Patent Application, Application No. 63/685,830, filed on Aug. 22, 2024.

### BACKGROUND OF THE INVENTION

### Field of the Invention

This invention relates generally to systems for electrifying lights attached to a rotating structure, such as the wheel rim on a motor vehicle, and more particularly to such systems in which the electrical source for the lights is the rotational kinetic energy of the rotating structure.

### Background of the Invention

Persistence of vision is a phenomenon in which a single light source is attached to a rotating surface, and the human eye perceives it as a continuous circular ring rather than an individual point of light. If a rotating surface, such as a wheel rim on a motor vehicle, rotates at a sufficient speed, and a single light source is mounted on the wheel rim and energized, the single light source creates a continuous ring effect visible to other drivers.

The light source attached to a wheel rim must be connected to an electricity source, such as a battery mounted on the wheel rim or to an intermediate structure that connects the light source to the motor vehicle's battery. One drawback with batteries mounted on the wheel rim is that they function as a weight that can cause wheel imbalances. Another drawback is that batteries have limited electrical charge and must be recharged or replaced regularly. One drawback of using an intermediate structure between the light source and the motor vehicle battery is that the intermediate structure must be sufficiently durable to operate under wet, windy, and dirty conditions.

Ideally, the intermediate structure should be mounted on the wheel rim and convert the wheel rim's rotational energy into electrical energy to power the light source. The intermediate structure should be easy to install without requiring extensive modification to the wheel rim or wheel hub, and it should be sufficiently durable to operate under wet, windy, and dirty conditions.

### SUMMARY OF THE INVENTION

A lightweight, simple ring wheel generator configured to convert rotational energy into electrical energy or convert electrical energy into rotational energy. In one embodiment, the generator is used to illuminate LED bulbs on a wheel rim or on a coil ring attached to the wheel rim.

The generator includes a coaxially aligned outer coil ring, an intermediate magnet ring, and an inner bracket ring. The outer coil ring includes a continuous serpentine coil that winds around spacers formed on the inside surface of the outer coil ring. The inner bracket ring features a circular raceway with ball bearings, into which the intermediate magnet ring is inserted. The magnet ring, which rotates freely inside the circular raceway, includes a plurality of radially aligned disc magnets aligned with their poles in opposite directions.

During assembly, the magnet ring is positioned inside the circular raceway, and the outer coil ring is mounted on the inside surface of the wheel rim. When the wheel rim is mounted on the wheel hub and the wheel rim and wheel hub are rotated, the outer coil ring rotates over the magnet ring and the bracket ring. As the wheel rim and wheel hub rotates, an electric current is induced in the coil wire. The coil wire is connected to one or more LED bulbs mounted at a visible location on the wheel rim, or on the coil ring at a position visible through the wheel rim thereby producing a persistence of vision effect to outside viewers.

### DESCRIPTION OF THE DRAWINGS

FIG. 1 is a side elevational view of a stationary motor vehicle tire mounted on a hub with a plurality of LED lights mounted on the outside surface of the outer coil ring

FIG. 2 is a side elevational view of the motor vehicle tire shown in FIG. 1 when rotated to produce a persistence of vision effect in which a single LED bulb creates a circular illuminating ring.

FIG. 3 is a side elevational view of a wheel rim on the hub of a motor vehicle with the ring wheel generator located on the inside surface of the wheel rim.

FIG. 4 is a top plan view of the inner bracket ring with a recessed raceway with a plurality of ball bearings evenly distributed inside the raceway.

FIG. 5 is a sectional side view of the inner bracket ring, shown along line 5-5 in FIG. 4.

FIG. 6 is a top plan view of the magnet ring, showing a plurality of disc magnets radially aligned and oriented with their poles aligned in opposite directions.

FIG. 7 is a side elevational view of the magnet ring shown in FIG. 6.

FIG. 8 is a top plan view of the coil ring showing a plurality of oval-shaped spacers radially aligned on the inside surface and a serpentine coil wound around the spacers.

FIG. 9 is a sectional view of the coil ring taken along line 9-9 in FIG. 8.

FIG. 10 is a diagram of a second embodiment showing the ring wheel generator used to convert electrical energy into rotational energy.

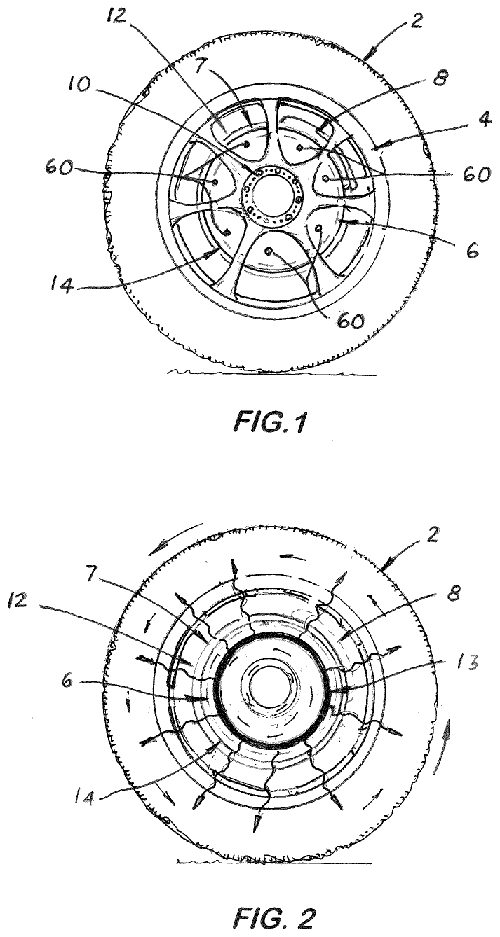

### DETAILED DESCRIPTION OF THE INVENTION

Disclosed herein is a ring wheel generator 12 that converts a wheel's rotational energy into electrical energy used to power lights or other electrical devices attached or coupled to the wheel rim 4.

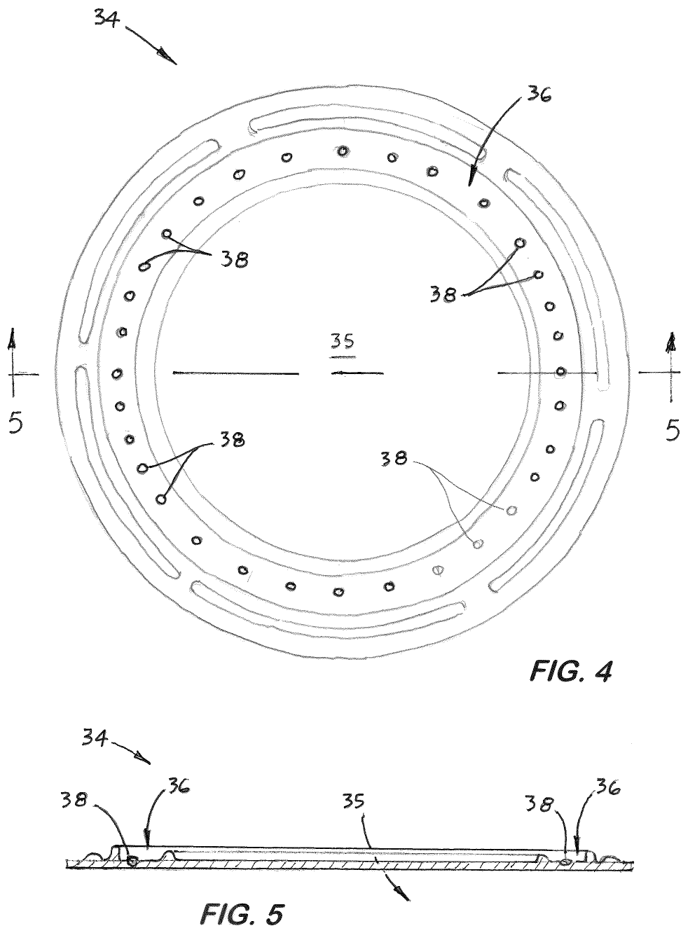

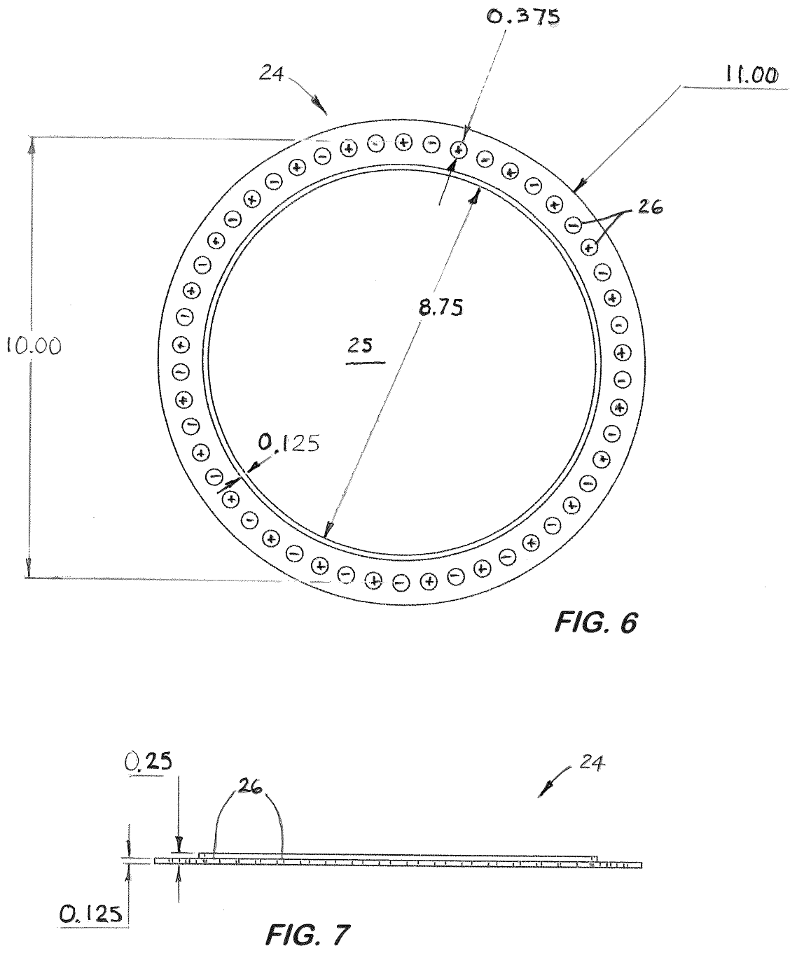

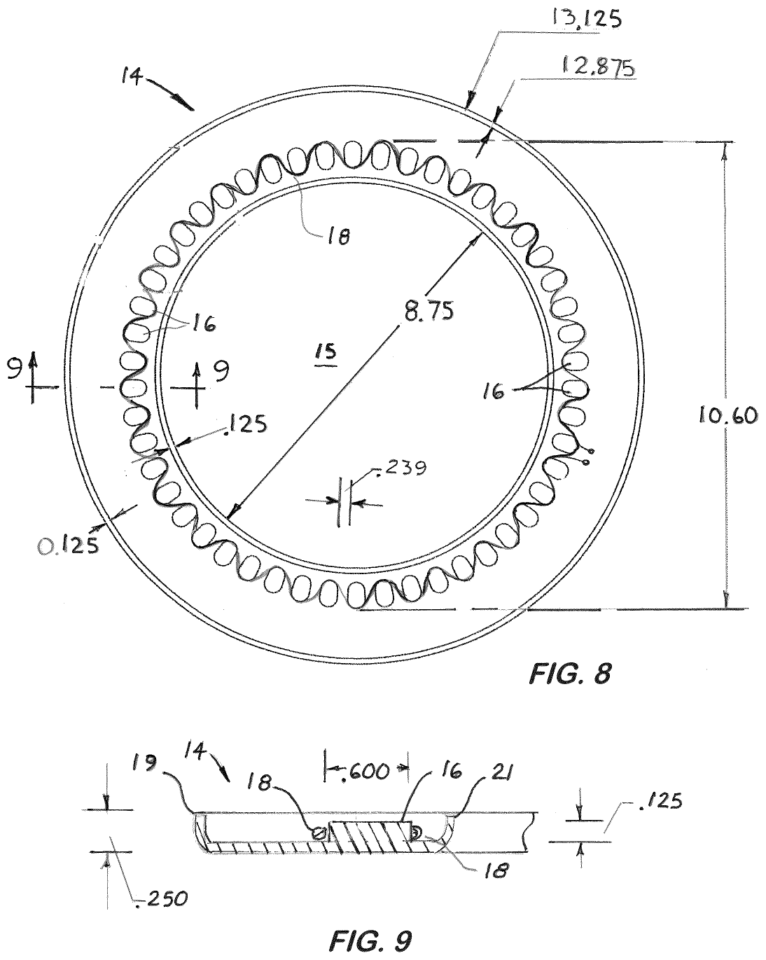

In the first embodiment, the ring wheel generator 12 is assembled on the inside surface of a wheel rim attached to a motor vehicle. The ring wheel generator 12 includes three stacked, coaxially aligned rings-an outer coil ring 14, shown in FIGS. 8 and 9, an intermediate magnet ring 24 shown in FIGS. 6 and 7, and an inner bracket ring 34 shown in FIGS. 4 and 5. The outer coil ring 14 is affixed to the inside surface of the wheel rim 4 and configured to rotate with the wheel rim 4. The intermediate magnet ring 24 is positioned between the outer coil ring 14 and the inner bracket ring 34. Each ring, 14, 24, 34 includes a center hole 15, 25, and 35, respectively, that fits around the hub 6 and enables the inside surface of the wheel rim 4 to press firmly against the outer surface of the hub 6 and attach to the hub using the hub's lug bolts 10 and nuts 12.

The outer coil ring 14 includes a plurality of spacers 16 located on its inside surface. Spacers 16 are radially and evenly spaced apart. Extending around spacers 16 is a continuous, serpentine-like coil winding 18 over the coil rings'inside surface. The coil 18 repeatedly bends inward and outward over spacers 16. Spacers 16 are located on the outer coil ring 14 so that the circular axis of spacers 16 is aligned with the circular center axis of the disc magnets 26 when the outer coil ring 14 is coaxially aligned over the magnet ring 24. The height of each spacer 16 is relatively short, allowing them to rotate freely over the disc magnets 26.

The opposite ends of the coil winding 18 extend outward and connect to one or more LED bulbs 60. LED bulbs 60 can be mounted on the outside surface of the wheel rim 4 or on the outer surface of the outer coil ring 14 visible through the wheel rim 4.

The inner bracket ring 34 includes a recessed circular raceway 36. Located inside the circular raceway 36 are a plurality of ball bearings 38.

Located inside the circular raceway 36 is a rotating magnet rig 24. Magnet ring 24 includes a plurality of thin disc magnets 26. The disc magnets 26 have a low profile and are radially aligned and evenly distributed on the outside surface. The North and South polarity of the adjacent disc magnets 26 are aligned in opposite directions. The magnet ring 24 fits inside the circular raceway 36. The inside surface of the magnet ring 24 rides over the ball bearings 38, enabling the magnet ring 24 to rotate freely inside the inner bracket ring 34.

During assembly, the magnet ring 24 is inserted into the circular raceway 36 formed on the inner bracket ring 34. When the wheel hub is attached to the hub, the outer coil ring 14 is then aligned coaxially over the magnet ring 24 and inner bracket ring 34. The outer coil ring 14 features outer and inner edges that bend inward, partially covering the outer and inner edges of the inner bracket ring 34, and preventing dirt and water from entering the space between the three rings. An optional outer lip 19 and inner lip 21 may be formed on the outside and inside edges of the outer coil ring 1, which holds the three rings in a stacked arrangement. The lips 19 and 21 still allow the outer coil ring 14 to rotate freely over the intermediate magnet ring 24 and the inner bracket ring 34.

After coaxially aligning the three rings together, the outer coil ring 14 is then mounted on the inside surface of the wheel rim 4 using suitable connectors (screws or clips). The wheel rim 4 is then mounted on the hub 6. A rigid bracket 50 attached at one end to the hub's back plate 9 extends outward and over the inner bracket ring 34. The distal end of bracket 50 may be attached directly to the inner bracket ring 34 to prevent the inner bracket ring 34 from rotating. An option break-away wire 52 may be used between the distal end of the bracket 50 and the inner bracket ring 34 that breaks if the inner bracket ring 34 becomes bound to the outer coil ring 14.

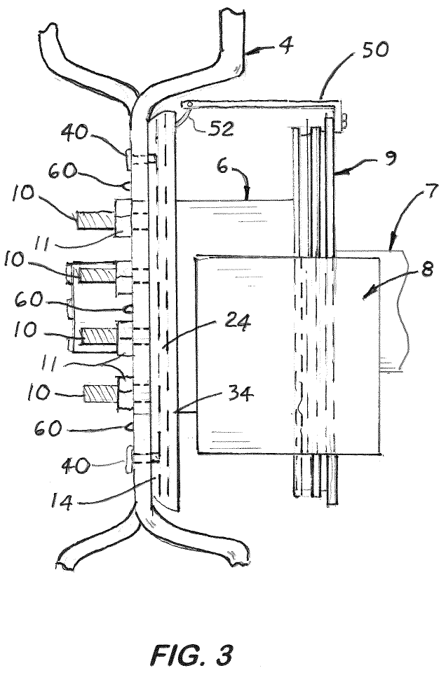

The wheel rim 4 may include a hub bore 5 configured to receive the hub 6 as shown in FIG. 3. When the wheel rim 4 is attached to the hub 6 and rotated, the outer coil ring 14 rotates around the magnet ring 24 and the inner bracket ring 34. An electric current is induced in the coil winding 18. At least one LED bulb 60 is electrically connected to the coil winding 18 and mounted on the outer coil ring 14 or mounted on the outside surface of the wheel rim 4. If mounted on the outer coil ring 14, the LED bulb 60 must be positioned at a location visible through the wheel rim 4. When the motor vehicle is driven at a sufficient speed, both wheel rim 4 and the outer coil ring 14 rotate. The inner bracket ring 34, which is attached to the backing plate 9 on the hub 6 via bracket 50, remains stationary. As the wheel rim 4 rotates, the intermediate magnet ring 24 also rotates freely over the inner bracket ring 34. Because the coil ring 14 rotates faster over the magnet ring 24, an electric current is produced in the coil winding 18, which energizes the LED bulbs 60. As the wheel rotates, a circular persistence of vision effect 13 (see FIG. 2) is produced.

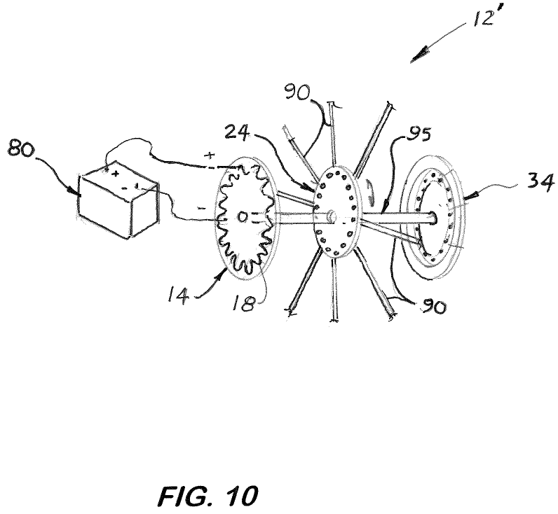

In a second embodiment, shown in FIG. 10, the ring wheel generator 12 is mounted between a fixed structure and a rotating structure with the relative positions of the three rings 14, 24, 34 reversed so that the coil ring 14 is stationary and mounted on a fixed structure (axle 95), and the magnet ring 24 coupled directly to a rotating structure, such as the wheel (not shown).

When electricity is applied to coil winding 18 on the outer coil ring 14 via a battery 80, an electric current in coil winding 18 creates a magnetic flux that causes the intermediate magnet ring 24 to rotate. By attaching the magnet ring 24 to a rotating object, such as a spoke 90 on a wheel, the electric current applied to the coil disc is converted into rotational energy.

In compliance with the statute, the invention described has been described in language more or less specifically as to structural features. It should be understood, however, that the invention is not limited to the specific features shown, since the means and construction shown, comprises the preferred embodiments for putting the invention into effect. The invention is therefore claimed in its forms or modifications within the legitimate and valid scope of the amended claims, appropriately interpreted under the doctrine of equivalents.

I claim:

1. A ring wheel generator comprising;
a bracket ring configured to fit around a wheel hub on a motor vehicle, said inner bracket ring includes a circular raceway with ball bearings;
a magnet ring coaxially aligned with said inner bracket ring, and configured to fit inside and rotate freely inside said circular raceway in said bracket ring, said magnet ring includes a plurality of disc magnets aligned radially, said disc magnets being aligned with their poles in opposite directions;
a coil ring coaxially aligned with said inner ring and said magnet ring, said coil ring include an inside surface, an outside surface, and an outer perimeter edge, said coil ring includes a continuous, circular coil winding configured to form a continuous serpentine coil winding that extends over and between said magnets on said magnet ring when said magnet ring is positioned in said coil ring;
at least one bracket attached to said bracket ring, said bracket configured to hold said bracket ring in a fixed position between said bracket ring and said coil ring; and
at least one connector that connects said coil ring to said wheel hub so that said coil ring rotates with said wheel hub; and,
whereby when said wheel hub is rotated, said coil ring rotates around the magnet ring thereby producing an electric current in the coil winding.

2. The ring wheel generator, as recited in claim 1, further includes at least one LED bulb connected to said coil.

3. The ring wheel generator, as recited in claim 2, wherein said LED bulb is mounted on said wheel rim.

4. The ring wheel generator, as recited in claim 1, wherein said serpentine coil winding is supported by a plurality of radially aligned spacers positioned on the inside surface of said coil ring.

5. The ring wheel generator, as recited in claim 1, wherein said bracket ring is secured to a fixed structure located near said wheel hub by a bracket assembly that includes a breakaway wire configured to disconnect in the event of mechanical binding.

6. A ring wheel generator for converting rotational energy into electrical energy, comprising:
a bracket ring configured to fit around a wheel hub of a motor vehicle, said inner bracket ring including a circular raceway on its inside surface and a plurality of ball bearings disposed within said circular raceway;
a magnet ring coaxially aligned with and rotatably positioned within said circular raceway of said bracket ring, said magnet ring comprising a plurality of radially aligned disc magnets with alternating magnetic poles;
a coil ring coaxially aligned with said inner bracket ring and said magnet ring, said coil ring comprising an inside surface with a continuous serpentine coil winding extending around a plurality of spacers formed on an inside surface of said coil ring, said coil winding configured to induce an electric current when said coil ring is rotated over said magnet ring;
at least one LED mounted on said wheel rim or on said coil ring, said LED being positioned making it visible when viewing said wheel hub;
a bracket assembly configured to secure the said bracket ring to a fixed structure adjacent said wheel hub, thereby preventing rotation of said bracket ring; and
a connector configured to attach said coil ring to said wheel rim such that the outer coil ring rotates with said wheel hub; and,
whereby when said wheel hub is rotated, said coil ring rotates around said magnet ring thereby producing an electric current in the coil winding and activating said LED and producing a persistence of vision effect when said wheel is rotated.

7. The ring wheel generator of claim 6, wherein said LED is mounted on the outer surface of said wheel rim.

8. The ring wheel generator of claim 6, wherein the serpentine coil winding forms a plurality of wave-like projections that pass over and between said disc magnets during rotation.

9. The ring wheel generator of claim 6, wherein the outer coil ring includes inwardly bent edges that partially enclose said bracket ring and said magnet ring to prevent ingress of dirt and moisture.

10. The ring wheel generator of claim 6, wherein the bracket assembly includes a breakaway wire configured to disconnect said inner bracket ring from the fixed structure in the event of mechanical binding.

11. A method for generating electrical energy using a ring wheel generator mounted on a motor vehicle wheel rim, comprising:
a. securing a bracket ring to a fixed structure adjacent to a wheel hub;
b. positioning a magnet ring within a circular raceway of said bracket ring such that said magnet ring rotates freely;
c. attaching a coil ring to said wheel rim such that said coil ring rotates with said the wheel rim;
d. aligning a serpentine coil winding on said coil ring over the disc magnets of the magnet ring;
e. rotating the wheel to induce an electric current in said coil winding; and
f. powering at least one LED bulb mounted on the wheel rim using the induced electric current in said coil winding.

12. The method of claim 11, wherein the serpentine coil winding is supported by a plurality of radially aligned spacers positioned on the inside surface of said coil ring.

13. The method of claim 11, wherein said magnet ring comprises a plurality of disc magnets radially aligned with alternating north and south poles to maximize magnetic flux interaction.

14. The method of claim 11, further comprising enclosing said inner bracket ring and said magnet ring with inwardly bent edges of said coil ring to prevent ingress of dirt and moisture.

15. The method of claim 11, wherein said bracket ring is secured to the fixed structure using a bracket assembly that includes a breakaway wire configured to disconnect in the event of mechanical binding.
